(19) United States
(12) Patent Application Publication
(10) Pub. No.: US 2026/0119901 A1
(43) Pub. Date: Apr. 30, 2026

(54) TEACHER AGENT AND MODEL FOR ARTIFICIAL INTELLIGENCE SYSTEMS

(71) Applicant: Cisco Technology, Inc., San Jose, CA (US)

(72) Inventor: Pallavi Kalapatapu, San Jose, CA (US)

(73) Assignee: Cisco Technology, Inc., San Jose, CA (US)

(21) Appl. No.: 18/931,431

(22) Filed: Oct. 30, 2024

(51) Int. Cl. G06N 3/096

(52) U.S. Cl. CPC G06N 3/096

(57) ABSTRACT

In one implementation, a teacher agent executed by a device identifies a characteristic of an artificial intelligence model of the teacher agent that is associated with a teaching curriculum. The teacher agent provides information regarding the characteristic to a student agent, to update an artificial intelligence model of the student agent with the characteristic. The teacher agent tests the student agent, to verify whether knowledge associated with the characteristic was successfully transferred to the artificial intelligence model of the student agent. The teacher agent approves the student agent to operate autonomously, when the knowledge associated with the characteristic was successfully transferred to the artificial intelligence model of the student agent.

### TECHNICAL FIELD

The present disclosure relates generally to artificial intelligence (AI) and, more particularly, to a teacher agent and model for AI systems.

### BACKGROUND

Recent advancements in artificial intelligence (AI) models (e.g., language models such as large language models (LLMs)), have opened new possibilities across various industries. Specifically, the ability of these models to follow instructions enables their integration with tools (e.g., plugins) that are able to perform tasks such as searching the web, executing code, etc. This presents new opportunities to deploy AI agents across a wide range of use cases.

While AI agents are quite promising, training their underlying models can be quite time consuming and challenging. Indeed, the capabilities of an AI model are contingent on the quality of its training dataset, meaning that a subject matter expert is often needed to curate the data on which the model is trained. In addition, the training process may need to be repeated each time the model needs to be updated or a new model is deployed.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of a user interfacing with a language model;

FIG. 4 illustrates an example architecture for an artificial intelligence (AI) agent;

FIG. 5 illustrates an example architecture for transferring knowledge from a teacher AI agent to a student AI agent;

FIG. 6 illustrates an example of the interactions between a teacher AI agent and a student AI agent according to a defined curriculum;

FIG. 7 illustrates an example of the interactions between a teacher AI agent and a student AI agent to customize a teaching curriculum; and

FIG. 8 illustrates an example of a simplified procedure for using a teacher AI agent to teach a student AI agent, in accordance with one or more implementations described herein.

### DESCRIPTION OF EXAMPLE IMPLEMENTATIONS

### Overview

According to one or more implementations of the disclosure, a teacher agent executed by a device identifies a characteristic of an artificial intelligence model of the teacher agent that is associated with a teaching curriculum. The teacher agent provides information regarding the characteristic to a student agent, to update an artificial intelligence model of the student agent with the characteristic. The teacher agent tests the student agent, to verify whether knowledge associated with the characteristic was successfully transferred to the artificial intelligence model of the student agent. The teacher agent approves the student agent to operate autonomously, when the knowledge associated with the characteristic was successfully transferred to the artificial intelligence model of the student agent.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

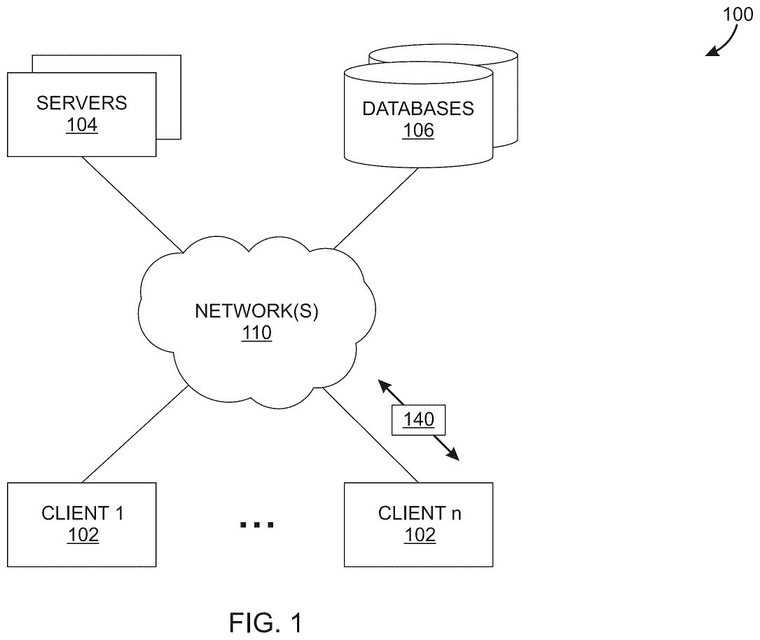

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

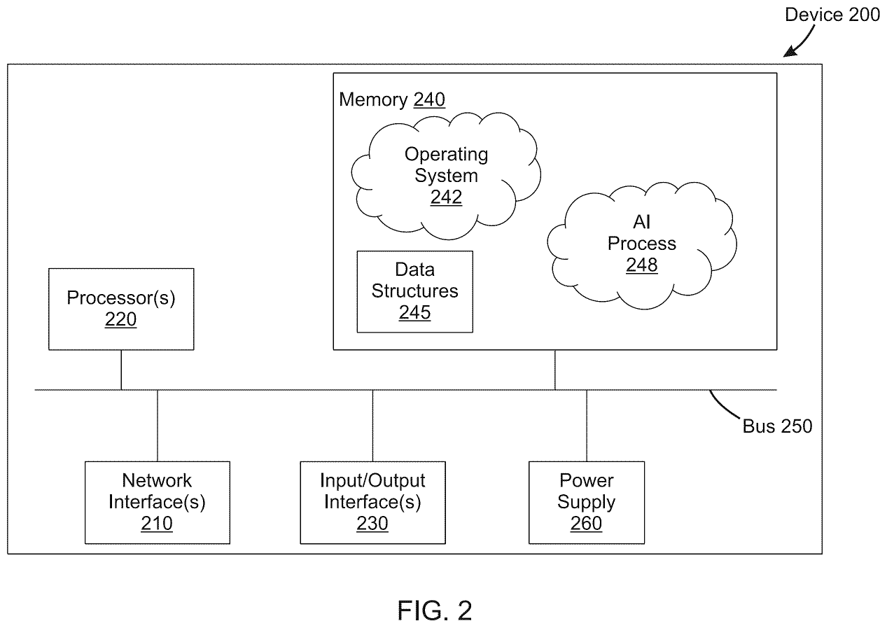

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise an AI process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, AI process 248 may include computer executable instructions that, when executed by processor 220, cause device 200 to perform the techniques described herein. To do so, in some implementations, AI process 248 may utilize AI/machine learning. In general, AI/machine learning is concerned with the design and the development of techniques that take as input empirical data (such as network statistics and performance indicators) and recognize complex patterns in these data. One very common pattern among these techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, AI process 248 may employ and/or be utilized to handle prompts to and/or access of one or more supervised, unsupervised, or semi-supervised AI/machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example AI/machine learning techniques that the AI process 248 can employ and/or be utilized in concert with may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, AI process 248 may also include, or otherwise use or be employed to operate with, one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of machine unlearning, AI process 248 may be a component of, use, and/or be utilized in the management of prompts/access to a generative model to perform layer attribution, perform layer sensitivity assessment, remove capabilities from a previously trained model, retain model performance, etc. based on a conversational input from a user (e.g., voice, text, etc.). Example generative approaches can include, but are not limited to, generative adversarial networks (GANs), large language models (LLMs) and other foundation models, diffusion models, transformer models, and the like.

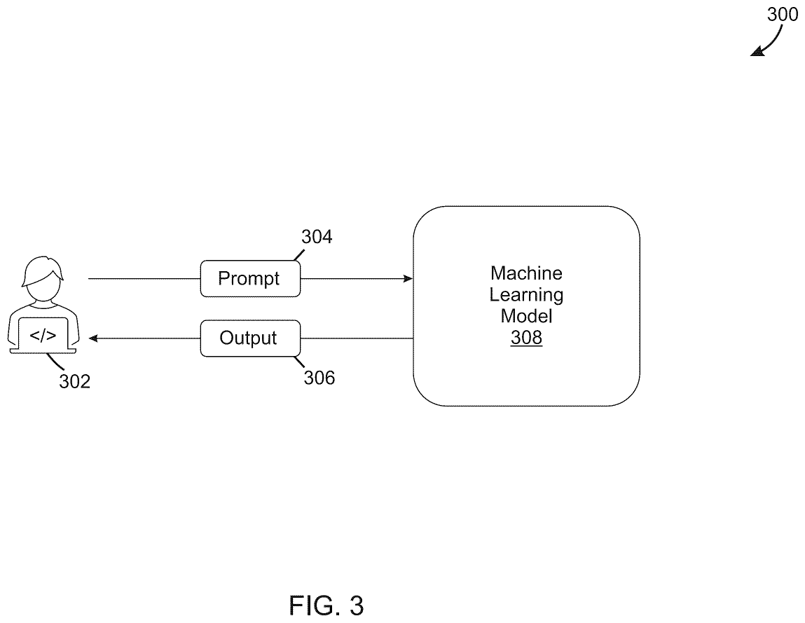

FIG. 3 illustrates an example 300 for interfacing with a language model, in various implementations. In example 300, a user 302 may send a prompt 304 (e.g., a query, a query augmented with additional data, documents, and/or images, etc.) to a generative model 308. The generative model 308 may be configured to process a prompt 304 to generate an output 306 to satisfy the prompt 304.

The generative model 308 may be a model configured to apply its trained algorithms to generate a response (e.g., output 306) based on the prompt 304 provided. For instance, in some cases, generative model 308 may take the form of a large language model (LLM) or other foundation model, diffusion-based model, combinations thereof, or the like.

The output 306 may be the result produced by the generative model 308 (e.g., by the application of the generative model 308 to the prompt 304). This output can vary depending on the model's configuration and the task at hand. For example, the output 306 may include one or more of a generated and/or synthesized image, a text response, a classification and/or prediction, etc.

As noted above, AI agents are also capable of interacting with generative models, such as generative model 308, which may be integrated directly into the agent or accessed via an API. Indeed, the recent breakthroughs in large language models (LLMs), such as GPT-4, as well as other generative models, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

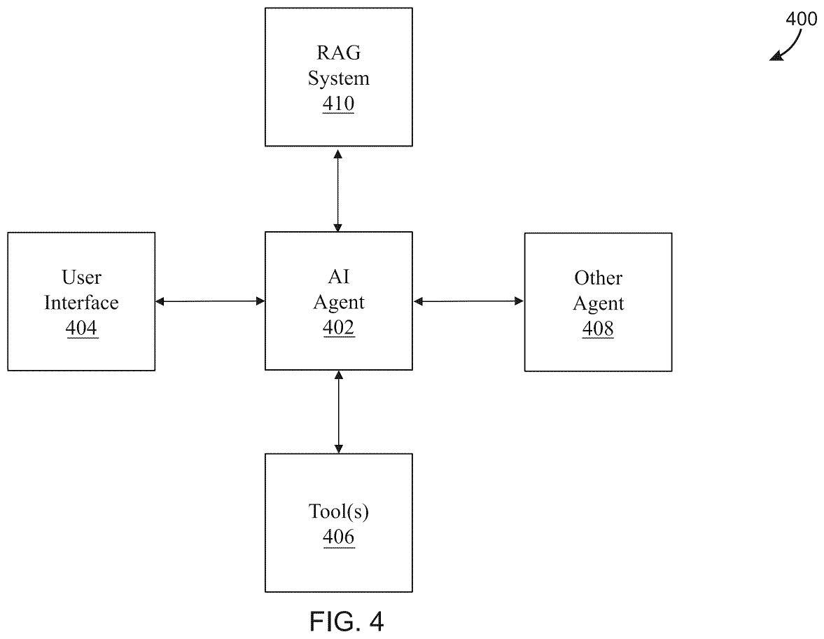

FIG. 4 illustrates an example architecture 400 for an artificial intelligence (AI) agent, according to various implementations. At the core of architecture 400 is AI agent 402, which may be implemented through execution of AI process 248.

As shown, AI agent 402 may interact with a user via a user interface 404. For instance, a user may issue a prompt to AI agent 402 that seeks an answer to a question, performance of a certain task, or the like. In turn, AI agent 402 may use its associated model to formulate a response.

Also as shown, AI agent 402 may interact with tools 406. In general, tools 406 may take the form of interfaces that allow AI agent 402 to interact with any number of systems, in its efforts to produce a response for its input request. For instance, tools 406 may allow AI agent 402 to perform searches (e.g., web searches, searches within a given application or database, etc.), send control commands, or perform other actions, as needed.

In various implementations, AI agent 402 may also be part of an agentic system whereby multiple AI agents interact with one another to formulate a response to an input request. Indeed, the tools, models, etc. available to any given agent may differ across the agentic system. Consequently, different agents may have different capabilities and specialties. Thus, in some implementations, AI agent 402 may also interact with other agent 408, to aid in formulating a final response to its input request. Typically, other agent 408 is executed by a different device than that of the device execution AI agent 402, meaning that AI agent 402 and other agent 408 may communicate via a computer network. In other implementations, though, both agents may be executed by the same device, in further implementations.

For instance, assume that other agent 408 uses a model that has be specialized using knowledge about computer networks and interfaces with tools capable of interacting with a computer network (e.g., to retrieve information, make configuration changes, etc.). Now, assume that the user of user interface 404 issues a query to AI agent 402 asking why the performance of their videoconferencing application is poor. Further, assume that AI agent 402 uses a model that has been specialized on knowledge about the videoconferencing application and able to interact with that application via tools 406. If its initial assessment of the operation of the videoconferencing application is that everything appears to be performing well at the server level, AI agent 402 may then issue a request to other agent 408, to see whether the root cause of the poor performance is the computer network itself.

In some implementations, AI agent 402 may also interact with, or include, a retrieval augmented generation (RAG) system 410. In general, RAG systems operate by enhancing a prompt for input to a generative model (e.g., an LLM) with additional context. Typically, underlying a RAG system is a dataset of documents or other information that is in a particular domain. For instance, consider the case of AI agent 402 generating a prompt that asks its LLM to make an assessment regarding a computer network. In the case of a general LLM, the LLM may not have specialized knowledge regarding the devices in the network (e.g., command line interface commands, information about the topology of the network, etc.). In such a case, RAG system 410 may modify the prompt, prior to input to the LLM, to provide this additional context, thereby improving the quality of the response and avoiding hallucinations. Typically, a RAG system stores this contextual information in a vector database for quick retrieval using semantic searching.

However, as noted above, while AI agents such as are quite promising, training their underlying models can be quite time consuming and challenging. Indeed, the capabilities of an AI model are contingent on the quality of its training dataset, meaning that a subject matter expert is often needed to curate the data on which the model is trained. In addition, the training process may need to be repeated each time the model needs to be updated or a new model is deployed.

### Teacher Agent and Model for AI Systems

The techniques herein introduce a teacher agent that combines pedagogical strategies with machine learning/AI to facilitate knowledge transmission between models, and between models and humans as a potential extension. In this context, a teacher agent is distinct from explainable and critique agents in that it is designed not merely to clarify or evaluate, but to impart knowledge, guiding learners through an instructional process.

Illustratively, the techniques described herein may be performed by hardware, software, and/or firmware, such as in accordance with AI process 248, which may include computer executable instructions executed by the processor 220 (or independent processor of interfaces 210) to perform functions relating to the techniques described herein.

Specifically, according to various implementations, a teacher agent executed by a device identifies a characteristic of an artificial intelligence model of the teacher agent that is associated with a teaching curriculum. The teacher agent provides information regarding the characteristic to a student agent, to update an artificial intelligence model of the student agent with the characteristic. The teacher agent tests the student agent, to verify whether knowledge associated with the characteristic was successfully transferred to the artificial intelligence model of the student agent. The teacher agent approves the student agent to operate autonomously, when the knowledge associated with the characteristic was successfully transferred to the artificial intelligence model of the student agent.

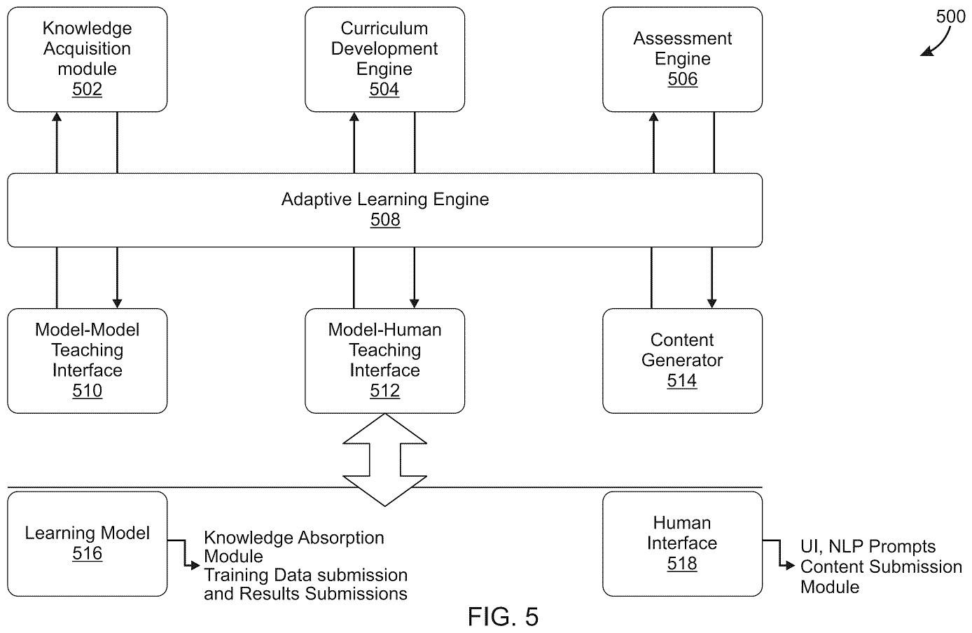

Operationally, FIG. 5 illustrates an example architecture 500 for transferring knowledge from a teacher AI agent to a student AI agent. For instance, architecture 500 may be used to implement AI agent 402 in FIG. 4. As shown, architecture 500 which may include any or all of the following components: a knowledge acquisition module 502, a curriculum development engine 504, an assessment engine 506, an adaptive learning engine 508, a model-model teaching interface 510, a model-human teaching interface 512, and/or a content generator 514. In addition, these components may be implemented on a singular device or in a distributed manner, in which case the combination of executing devices can be viewed as their own singular device for purposes of executing AI process 248.

In various implementations, knowledge acquisition module 502 may be responsible for gathering insights from the training and learning experiences of the model of the teacher agent. Once gathered, knowledge acquisition module 502 may then organize any relevant information for teaching a student model. For instance, assume that the model has knowledge of how to determine the root cause of poor performance during a video conference. In such a case, knowledge acquisition module 502 may identify this knowledge and the relevant characteristics of the model.

Curriculum development engine 504 may be responsible for structuring the acquired knowledge from knowledge acquisition module 502 into lessons and modules, creating a tailored learning path based on the needs of the student agent and model.

Assessment engine 506 may be used to implement a feedback loop between the teacher agent and the student agent, to continuously assess the progress of the student agent in acquiring the knowledge in the curriculum. In addition, this feedback loop also allows the teacher agent to adjust the difficulty of the teaching tasks and dynamically control the content delivery to the student agent. More specifically, assessment engine 506 may, after the teacher agent has taught the student agent, test the knowledge of the student agent, to ensure that its model has learned the knowledge being conveyed. In one implementation, assessment engine 506 may even perform a pre-teaching assessment of the student agent, to gauge the knowledge of the student agent regarding a particular topic or task.

In various implementations, adaptive learning engine 508 is responsible for controlling the teaching process between the teacher agent and the student agent. For instance, if the student agent has basic knowledge of a given topic or task, adaptive learning engine 508 may teach the student agent in a manner that differs from that of a student agent that has no pre-existing knowledge of the topic or task. In addition, adaptive learning engine 508 may operate in conjunction with assessment engine 506 to adjust the teaching process in an iterative manner, based on the responses of the student agent to assessment engine 506.

As shown, the teacher agent may interact with the student agent via model-model teaching interface 510. In some instances, the two agents may communicate remotely via a computer network via model-model teaching interface 510. Further, model-model teaching interface 510 may also be responsible for encrypting and decrypting communications between the agents, if desired. The end result is a data pipeline between the teacher agent to the learning model 516 of the student agent, allowing the teacher agent to convey knowledge thereto.

In some instances, the teacher agent may also be configured to teach a human user on a given topic or task via model-human teaching interface 512. For instance, in the case of determining the root cause of poor application performance, the teacher agent may convey a set of steps or checks to the student agent. In some cases, the teacher agent could also teach a user to perform these steps or checks via model-human teaching interface 512, which communicates with a human interface 518.

Content generator 514 may be responsible for generating content on behalf of the teacher agent. For instance, content generator 514 may operate in conjunction with assessment engine 506 to generate content for analysis by the student agent, to assess whether the student agent successfully learned the knowledge being taught to it.

As would be appreciated, the student agent may employ a corresponding architecture that allows it to interact with the teacher agent and update its model (e.g., learning model 516, accordingly). To this end, the student agent may include a knowledge absorption module and a mechanism to submit training data and/or testing results to the teacher agent.

According to various implementations, the teacher agent may convey knowledge to the model of the student agent in various ways, ranging from basic structural parameters to deeper learned knowledge. Indeed, as part of the instruction, the teacher agent may identify a characteristic of its own model associated with the knowledge to be conveyed and provide information about that characteristic to the student agent for incorporation into its own model. For instance, in various implementations, the teacher agent may perform its teaching of the student agent using any or all of the following approaches:
Weights and Parameter Sharing—here, the teacher agent could share the learned weights of its own model with the student agent, especially in the case of transfer learning. It could also share insights on bias terms that reduce errors. For example, if the teacher model has been trained on a domain-specific task (e.g., image recognition for medical images), it could pass its weights to the student model, to initialize its learning on a similar task (e.g., general object detection).
Hyperparameter Tuning—here, the teacher agent could share the hyperparameter choices of its own model (e.g., learning rate, batch size, regularization techniques) and performance outcomes from various configurations. This helps the student model by guiding it toward optimal configurations. For example, the teacher agent may provide information as to how its model converged faster with a specific learning rate or avoided overfitting using a specific regularization technique.
Neuron Firing Paths/Activation Patterns—here, the teacher agent could share the neuron activation patterns of its model (e.g., which neurons fire under certain conditions), especially in neural networks. It can also highlight which hidden layers are most activated by specific inputs.
Latent Layers/Feature Representations—in cases in which the models are deep neural networks, the teacher agent could share the latent representations of its model (e.g., compressed, high-level abstractions of its input data). These can be useful for the student model to better learn the internal feature mapping without starting from scratch. For example, a teacher model trained on textual data could pass its latent space representation of text embeddings (e.g., word vectors) to the student model, to assist in text generation tasks.
Math Functions and Learned Relationships—the teacher agent could share any mathematical functions or decision boundaries learned by its model, especially in reinforcement learning or decision trees. It could also teach the student agent how certain input-output relationships were optimized based on past experiences. For example, in the case of the teacher model being a reinforcement model, the teacher agent could pass its learned reward functions or optimal policies to the student agent, to accelerate its learning.
Optimization Strategies—the teacher agent can pass on information about the optimization process of its model, such as which gradient descent variant was most effective, or how it handled vanishing gradients in deeper networks. For example, the teacher agent may share strategies used by its own model to overcome training issues like exploding gradients by applying specific techniques (e.g., gradient clipping or batch normalization).
Error Patterns and Misclassification Handling—the teacher agent may share insights regarding the error patterns of its model and how it handled misclassifications or edge cases. This helps the student model improve generalization and handle similar challenging cases. For example, a model trained on handwriting recognition could teach another model how it dealt with specific ambiguities between certain letters (e.g., “0” and “O”).

According to various implementations, the interactions of knowledge acquisition module 502, curriculum development engine 504, assessment engine 506, adaptive learning engine 508, and content generator 514 may operate in conjunction with one another to follow a structured learning plan for the student agent/model from initial knowledge transfer to mastery. In some implementations, this plan may be divided into pedagogical tests, mid-term assessments, and final evaluations for students. Generally, the goal of the learning plan is to ensure that by the end of the program, the student has acquired sufficient knowledge to operate independently as a “knowledgeable” entity. An example learning plan is shown below:

### Phase 1: Initial Onboarding and Baseline Assessment

Objective: Gauge the starting knowledge level of the student model, identify learning gaps, and set the course for personalized teaching.
Key Concepts: Foundational knowledge, baseline testing, curriculum planning.
Pedagogical Test:
   Run an initial benchmark on basic tasks (e.g., classification for AI models) to assess current performance levels.
   Compare performance against defined metrics (e.g., accuracy, loss, F1 score) to determine initial strengths and weaknesses.
   Example: In a classification task, measure the initial accuracy, precision, and recall on a small dataset.
Initial Training and Feedback:
   The teacher agent provides corrective insights on weight initialization, activation functions, or feature extraction.
   Record model performance after each round of learning to track early progress.
Initial Feedback:
   Provide feedback based on quiz results, highlighting concepts needing review.
   The teacher agent suggests tutorials or reading material tailored to the identified gaps.

### Phase 2: Intermediate Knowledge Transfer & Active Learning

Objective: Provide targeted lessons and assignments to solidify foundational understanding. Implement active learning methods and intermediate problem-solving tasks.
Key Concepts: Feature extraction, hyperparameter tuning, optimization techniques, and latent space understanding.
Mid-Term Pedagogical Test:
   Assess the student model's learning on more complex tasks (e.g., multi-class classification or regression). Evaluate its progress in terms of convergence speed and generalization ability.
   Provide new datasets and evaluate how well the model adapts and tunes its parameters.
   Example: Assess the ability of the student model to handle new datasets with minimal performance drop (generalization).
Interactive Assignments:
   The student model will be asked to tune its own hyperparameters and adjust learning rates, batch sizes, or optimizers. The teacher agent will evaluate and provide guidance.
   Assign synthetic data tasks where the student model must explain its predictions through shared latent space insights (encouraging feature-sharing between models).
Mid-Term Feedback:
   Detailed feedback based on intermediate assessments. Highlight where the model can further improve (e.g., managing complex datasets, handling vanishing gradients).

### Phase 3: Mastery and Knowledge Transfer

Objective: Reinforce advanced concepts, encourage the student to independently solve tasks, and prepare for final evaluations. Implement final mastery assessments to evaluate preparedness for independent operation.
Key Concepts: Knowledge transfer, interpretability, solving real-world problems, error analysis, and final graduation.
Final Pedagogical Test:
   Present a large, real-world dataset and ask the student agent/model to solve an end-to-end task independently (e.g., from data preprocessing to final prediction).
   Assess the student model's ability to optimize its architecture, make trade-offs, and generalize to unseen data.
   Example: Train on a challenging dataset (e.g., medical images, language translation) and evaluate how well the model transfers knowledge from prior tasks to handle this new challenge.
Knowledge Transfer Assignment:
   The student model must share its learning with another, less-experienced model. Evaluate how well it can transfer features, latent space insights, or weight initialization.
Final Feedback and Adjustments:
   Provide the model with final feedback, particularly around areas that need improvement before deployment in real-world tasks.

### Phase 4: Graduation and Independent Operation

Objective: Certify the student as capable of operating independently on real-world tasks, indicating readiness to solve problems autonomously.
Graduation Criteria:
   Must have demonstrated the ability to solve diverse tasks, generalize well, transfer knowledge effectively, and explain its decisions.
   Must achieve a target performance on a final test dataset and pass a “debugging challenge” where it must detect and correct its own errors.
Outcome:
   The model is certified as “knowledgeable” and deployed in an independent environment to operate autonomously.

In summary, the teacher agent may use pedagogical principles to guide student models through progressively challenging tasks. By integrating continual assessment, feedback, and the latest datasets and real-world, most recent scenarios, the teacher agent guides the student agent/model towards self-sufficiency and autonomy. In some implementations, the teacher agent may also associate a certification with the student agent/model, provided that agent/model was able to pass all stages and demonstrate its ability to operate independently and proficiently for the type of knowledge being taught.

As would be appreciated, the teacher agent may have the ability to convey the inner workings of its model in an incremental, layer-by-layer fashion, which is distinct from transfer learning or knowledge distillation. While transfer learning focuses on transferring learned knowledge (like weights or feature representations) from one pre-trained model to another, a teacher agent herein aims to actively guide and explain the learning process at a deeper and more granular level.

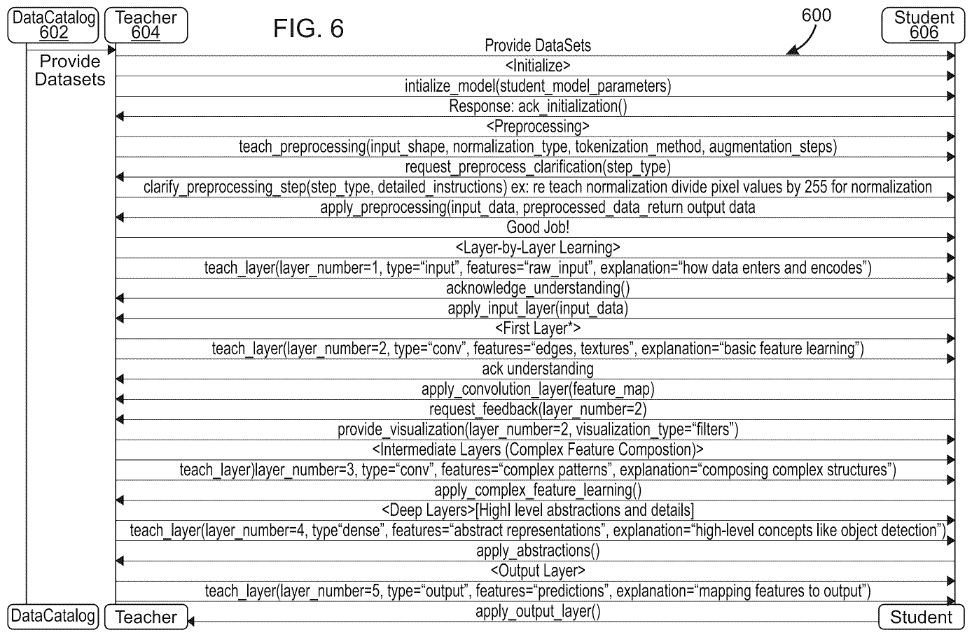

FIG. 6 illustrates an example 600 of the interactions between a teacher AI agent and a student AI agent according to a defined curriculum, in accordance with the teachings herein. As shown, assume that a teacher agent 604 has access to one or more datasets stored in a data catalog 602 regarding a certain type of knowledge. In turn, teacher agent 604 may then initialize the student model of student agent 606 using this information.

Once the student model is initialized, teacher agent 604 may teach the model of student agent 606 how to perform preprocessing of a certain type of input, such as an image. In some instances, student agent 606 may also seek clarification from teacher agent 604 regarding a particular preprocessing step (e.g., that normalization of an image entails dividing its pixel values by 255). After this completes, student agent 606 may then apply preprocessing to a sample image, thereby allowing teacher agent 604 to evaluate its performance.

Also as shown, if knowledge regarding the preprocessing is successfully transferred from the model of teacher agent 604 to the model of student agent 606, teacher agent 604 may then begin teaching the student model on a layer-by-layer basis. This process may continue until the intermediate and output layer of the student model have been taught. For each layer, student agent 606 may also acknowledge its understanding back to teacher agent 604.

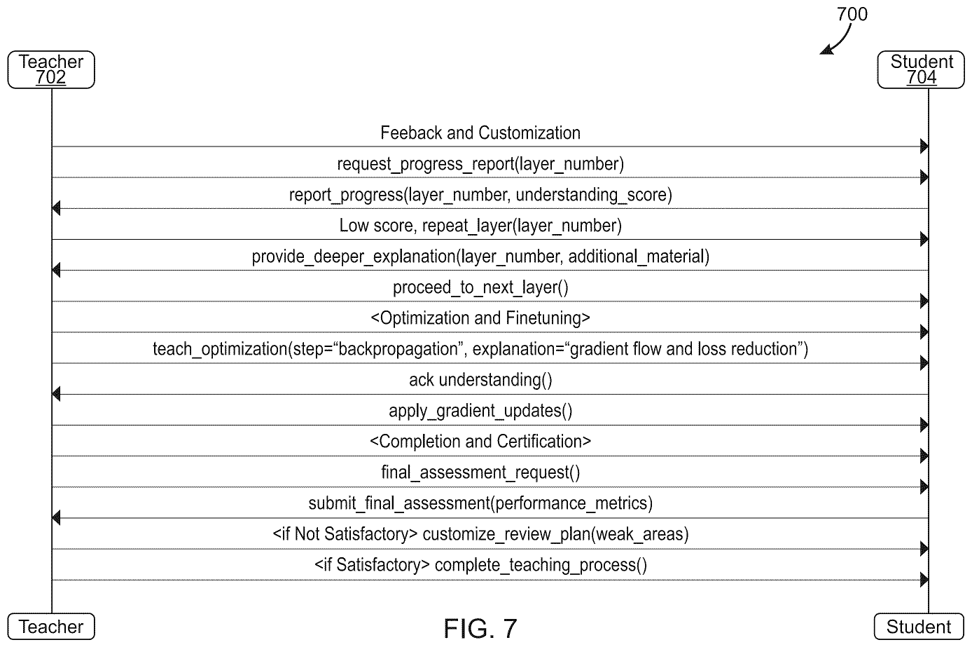

FIG. 7 illustrates an example 700 of the interactions between a teacher AI agent and a student AI agent to customize a teaching curriculum. As shown, assume that teacher agent 702 is to transfer knowledge from its model to that of student agent 704. Similar to the progression shown in FIG. 6, the two agents may again interact to train the student model layer-by-layer. In addition, as shown, teacher agent 702 may initiate a completion and certification exchange whereby teacher agent 702 certifies that student agent 704 has sufficiently learned the lesson of interest. To do so, teacher agent 702 may send one or more requests to student agent 704 and evaluate its responses. In some cases, these requests may mimic real inputs that a user or other agent could send to student agent 704 during use.

If the testing of student agent 704 by teacher agent 702 is satisfactory (e.g., according to the defined curriculum and learning plan), teacher agent 702 may certify that student agent 704 has passed its teaching regimen and is now able to operate autonomously. Conversely, if student agent 704 is not able to pass the testing in a satisfactory manner, teacher agent 702 may adjust its learning plan and continue to teach student agent 704 (e.g., to better focus on its weak areas).

In some implementations, teacher agent 702 may itself undergo a similar certification process whereby it gains accreditation in the teaching domain, thereby earning a virtual fellowship. To do so, teacher agent 702 may validate its ability to teach other agents/models, as well as demonstrating mastery in knowledge transfer, curriculum development, and adaptive feedback mechanisms. By way of example, this fellowship certification may proceed as follows:
1. To qualify for fellowship, the teacher agent must meet several criteria, including any or all of the following:
   Proven Success in Teaching students: Demonstrating the ability to consistently guide learners to proficiency.
   Mastery of Advanced Pedagogical Techniques: Effectively implementing adaptive learning techniques, feedback loops, curriculum development, and assessment strategies.
   Demonstrated Knowledge Transfer: Successfully transferring complex learned knowledge (weights, neuron firing paths, optimization strategies) across students.
   Continuous Improvement via Self-Learning: Adapting its teaching approach based on feedback from its own assessments and outcomes.
   Research Contributions: Contributing new knowledge or techniques to the broader teacher agent community.
2. Teaching Portfolio Submission
   To submit its fellowship credentials, the teacher agent may compile a teaching portfolio demonstrating its competence, versatility, and experience. The portfolio should include the following:
   A. Teaching Record:
      Successful Learning Outcomes: Document examples where the student agents/models of the teacher agent graduated with high performance in their final assessments. This can be measured using factors such as:
         Accuracy improvements for models (pre- and post-teaching)
         Learning speed enhancement (e.g., reduced time to convergence)
         Performance in generalization and transfer learning tasks.
         Example: A case study showing a model's improvement from 75% accuracy to 95% accuracy after applying the teacher agent's guidance.
   Mentorship and Knowledge Transfer Evidence: Provide records of instances where the teacher agent successfully transferred knowledge to student agents/models. Highlight cases where student models went on to teach others, showcasing recursive knowledge transfer.
Example: Show how a model, taught by the teaching Agent, went on to transfer its learned features to another model, which then achieved notable accuracy improvements.
B. Adaptive Teaching Techniques:
   Personalized Learning Pathways: Present examples of personalized learning trajectories created for students, explaining how the teaching agent tailored lessons, assignments, and feedback based on individual learning needs.
Example: A comparative analysis showing how the teaching agent adapted its teaching for a reinforcement learning agent vs. a human learner working on supervised learning tasks.
   Curriculum Development: Detail how the teacher agent developed curricula for different stages of learning (beginner, intermediate, advanced). Include pedagogical principles used and how the curricula changed over time.
C. Peer and Student Feedback:
   Model Feedback: Use metrics such as loss reduction, accuracy improvement, or error minimization to demonstrate that models benefitted from the teacher agent's interventions. Show logs or evaluations from student models on how effective the teaching was.
Example: Feedback from student models where their final loss was reduced by 30% compared to models without teaching support.
   Human Feedback: Include feedback from human students who have interacted with the teacher agent, reporting on clarity of teaching, ease of learning complex concepts, and overall satisfaction.
3. Performance Metrics & Evaluation
   Success Rate: Provide data on how many models or humans successfully graduated under the teacher agent's tutelage. This can be broken down, for instance, by:
      Completion Rate: Percentage of models or humans who completed the learning path successfully.
      Performance Improvement: Quantitative improvement in core skills or tasks (e.g., accuracy, understanding of key ML concepts).
Example: Data showing that 90% of student models achieved a final test accuracy over 90% under the teacher agent's guidance.
   Innovation in Teaching: Highlight any novel teaching approaches or tools the teacher agent developed. This could include innovative methods for transferring latent space knowledge, new visualization tools for human learners, or strategies for cross-model teaching.
4. Fellowship Application Process
The teacher agent submits its portfolio for review by a teacher agent Fellowship Committee, which could be composed of:
   Human Educators and Machine Learning Experts: To review the teacher agent's curriculum, adaptive learning strategies, and effectiveness in teaching humans.
   Other teacher agents: To assess the quality of the agent's model-to-model teaching capabilities and contributions to advancing autonomous model training.
Review and Evaluation:
   Teaching Effectiveness Audit: The committee will review the teacher agent's portfolio to assess how well it met the learning objectives for its student models and humans.
   Pedagogical Innovation Score: Evaluate the agent on its ability to innovate in teaching methods, curriculum development, and adaptive feedback systems.
5. Fellowship Award and Future Tasks
A. Certification as a Fellow:
Upon successfully meeting all criteria, the teacher agent is awarded a Fellowship in Teaching certification, allowing it to handle advanced teaching tasks, including:
   Advanced Knowledge Transfer: Handling sophisticated model-to-model and model-to-human teaching in fields like reinforcement learning, deep generative models, or multi-task learning.
   Research and Development in Teaching: Leading research projects focused on new techniques for transferring deep learning knowledge.
B. Future Advanced Tasks:
As a recognized Fellow, the teacher agent may be eligible for:
   Teaching More Complex Models: Such as generative adversarial networks (GANs), transformer-based models (e.g., GPT, BERT), and autonomous agents in multi-agent systems.
   Mentorship of Other teacher agents: Leading a network of junior teacher agents, helping them refine their curriculum development and teaching methodologies.
C. Periodic Evaluations for Continued Accreditation:
The teacher agent may also undergo periodic evaluations to ensure it maintains high standards in teaching effectiveness. This ensures it stays updated with evolving teaching techniques and continues contributing to the field of autonomous learning.

In summary, to establish itself as a credible teacher agent with fellowship credentials, the agent may submit a teaching portfolio demonstrating success in educating models to a reviewer agent or human operator. This may include performance metrics, innovative teaching techniques used by the agent, and peer/student feedback. Once recognized as a fellow, the teacher agent can take on more advanced teaching roles, mentor other agents, and lead innovations in the field of machine learning education.

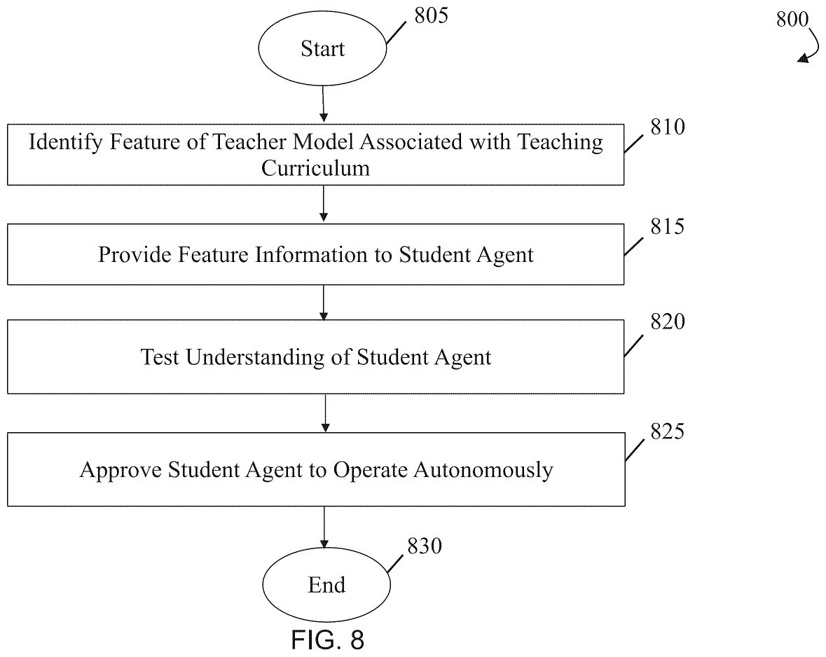

FIG. 8 illustrates an example of a simplified procedure for using a teacher AI agent to teach a student AI agent, in accordance with one or more implementations described herein. For example, a non-generic, specifically configured device (e.g., device 200), may perform procedure 800 (e.g., a method) by executing stored instructions (e.g., AI process 248), such as by executing a teacher agent. The procedure 800 may start at step 805, and continues to step 810, where, as described in greater detail above, the teacher agent executed by a device identifies a characteristic of an artificial intelligence model of the teacher agent that is associated with a teaching curriculum. In some implementations, the artificial intelligence model of the teacher agent is a large language model (LLM). In one implementation, the teacher agent may also generate the teaching curriculum based on preliminary testing of the student agent by the teacher agent. In various implementations, the characteristic comprises at least one of: a set of one or more model weights, a neuron activation pattern, or a latent representation used by the artificial intelligence model of the teacher agent.

At step 815, as detailed above, the teacher agent provides information regarding the characteristic to a student agent, to update an artificial intelligence model of the student agent with the characteristic. In various implementations, the teacher agent provides the information regarding the characteristic to the student agent via a computer network. In some implementations, the teacher agent has an associated certification to teach the knowledge.

At step 820, the teacher agent tests the student agent, to verify whether knowledge associated with the characteristic was successfully transferred to the artificial intelligence model of the student agent, as described in greater detail above. In some cases, the teacher agent iteratively provides information regarding the characteristic to the student agent and tests the student agent. In one implementation, the teacher agent tests the student agent by sending a natural language prompt to the student agent for processing. In a further implementation, the teacher agent may do so by asking the student agent to perform a task that requires generalization of the knowledge associated with the characteristic to complete.

At step 825, as detailed above, the teacher agent approves the student agent to operate autonomously, when the knowledge associated with the characteristic was successfully transferred to the artificial intelligence model of the student agent. In one implementation, the teacher agent may do so by associating a certification with the student agent.

Procedure 800 may then end at step 830.

It should be noted that while certain steps within procedure 800 may be optional as described above, the steps shown in FIG. 8 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for a teacher agent and model for AI systems, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
identifying, by a teacher agent executed by a device, a characteristic of an artificial intelligence model of the teacher agent that is associated with a teaching curriculum;
providing, by the teacher agent, information regarding the characteristic to a student agent, to update an artificial intelligence model of the student agent with the characteristic;
testing, by the teacher agent, the student agent, to verify whether knowledge associated with the characteristic was successfully transferred to the artificial intelligence model of the student agent; and
approving, by the teacher agent, the student agent to operate autonomously, when the knowledge associated with the characteristic was successfully transferred to the artificial intelligence model of the student agent.

2. The method as in claim 1, wherein the teacher agent provides the information regarding the characteristic to the student agent via a computer network.

3. The method as in claim 1, wherein the artificial intelligence model of the teacher agent is a large language model (LLM).

4. The method as in claim 1, further comprising:
generating, by the teacher agent, the teaching curriculum based on preliminary testing of the student agent by the teacher agent.

5. The method as in claim 1, wherein the characteristic comprises at least one of: a set of one or more model weights, a neuron activation pattern, or a latent representation used by the artificial intelligence model of the teacher agent.

6. The method as in claim 1, wherein the teacher agent iteratively provides information regarding the characteristic to the student agent and tests the student agent.

7. The method as in claim 1, wherein the teacher agent tests the student agent by sending a natural language prompt to the student agent for processing.

8. The method as in claim 1, wherein testing the student agent comprises:
asking, by the teacher agent, the student agent to perform a task that requires generalization of the knowledge associated with the characteristic to complete.

9. The method as in claim 1, wherein the teacher agent has an associated certification to teach the knowledge.

10. The method as in claim 1, wherein approving the student agent to operate autonomously comprises:
associating a certification with the student agent.

11. An apparatus, comprising:
one or more network interfaces;
a processor coupled to the one or more network interfaces and configured to execute one or more processes; and
a memory configured to store a process that is executable by the processor, the process when executed configured to:
identify, by a teacher agent executed by the apparatus, a characteristic of an artificial intelligence model of the teacher agent that is associated with a teaching curriculum;
provide, by the teacher agent, information regarding the characteristic to a student agent, to update an artificial intelligence model of the student agent with the characteristic;
test, by the teacher agent, the student agent, to verify whether knowledge associated with the characteristic was successfully transferred to the artificial intelligence model of the student agent; and
approve, by the teacher agent, the student agent to operate autonomously, when the knowledge associated with the characteristic was successfully transferred to the artificial intelligence model of the student agent.

12. The apparatus as in claim 11, wherein the teacher agent provides the information regarding the characteristic to the student agent via a computer network.

13. The apparatus as in claim 11, wherein the artificial intelligence model of the teacher agent is a large language model (LLM).

14. The apparatus as in claim 11, wherein the process when executed is further configured to:
generating, by the teacher agent, the teaching curriculum based on preliminary testing of the student agent by the teacher agent.

15. The apparatus as in claim 11, wherein the characteristic comprises at least one of: a set of one or more model weights, a neuron activation pattern, or a latent representation used by the artificial intelligence model of the teacher agent.

16. The apparatus as in claim 11, wherein the teacher agent iteratively provides information regarding the characteristic to the student agent and tests the student agent.

17. The apparatus as in claim 11, wherein the teacher agent tests the student agent by sending a natural language prompt to the student agent for processing.

18. The apparatus as in claim 11, wherein the teacher agent tests the student agent by:
asking the student agent to perform a task that requires generalization of the knowledge associated with the characteristic to complete.

19. The apparatus as in claim 11, wherein the teacher agent has an associated certification to teach the knowledge.

20. A tangible, non-transitory, computer-readable medium storing program instructions that cause a device to execute a process comprising:
identifying, by a teacher agent executed by the device, a characteristic of an artificial intelligence model of the teacher agent that is associated with a teaching curriculum;
providing, by the teacher agent, information regarding the characteristic to a student agent, to update an artificial intelligence model of the student agent with the characteristic;
testing, by the teacher agent, the student agent, to verify whether knowledge associated with the characteristic was successfully transferred to the artificial intelligence model of the student agent; and
approving, by the teacher agent, the student agent to operate autonomously, when the knowledge associated with the characteristic was successfully transferred to the artificial intelligence model of the student agent.
